(19) United States
(12) Patent Application Publication
(10) Pub. No.: US 2002/0170074 A1
(43) Pub. Date: Nov. 14, 2002

(54) Recording of interactive applications

(75) Inventors: Richard J. Houldsworth, Horley (GB); Octavius J. Morris, Redhill (GB)

Correspondence Address: Michael E. Marion, Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/139,176

(22) Filed: May 6, 2002

(30) Foreign Application Priority Data
May 4, 2001 (GB) 0111008.9

(51) Int. Cl. H04N 7/173; H04N 7/16; H04N 7/18; H04N 9/47; G06F 9/00; G06F 9/46

(52) U.S. Cl. 725/142; 725/134; 725/139; 709/328

(57) ABSTRACT

A transmission system, comprising a transmitter (10) and at least one receiver (14) is configured to receive signals (12) transmitted therefrom. Broadcast data in the transmitted stream is accompanied by one or more applications defined in one or more data carousels formed of data file and directory objects sent in cycles with predetermined groups of file and directory objects being formed into respective modules at the transmitter and with each module being transmitted as a whole. For each object carousel defining the root hierarchy of the data objects there is transmitted in the stream a list of identifiers for the component data carousels respectively defining all or a part of the data objects associated with an application. The receiver (14) is arranged, on identification of a particular application to be recorded, to use the list of identifiers to identify and subsequently store the received file data and directory objects for that application.

The present invention relates to methods and apparatus for the recording of digital broadcast material and in particular to the recording of interactive or multimedia applications accompanying television broadcasts.

A broadcaster can broadcast multimedia platform-specific applications possibly together with digital television programs. A suitably equipped multimedia platform-specific set-top box can receive those applications and run them locally. Example applications are electronic program guides, play-along games, Tele-banking, Tele-shopping, electronic newspapers and similar information services. Television programs can be recorded and, if such a television program has an application associated with it, for example a sports data or teletext application accompanying the live broadcast of a sporting fixture, then that application should also be recorded. Typically multimedia platform-specific applications are broadcast in an object carousel, where all the application code and data is broadcast in cycles. This resembles teletext data, which is also broadcast in a carousel.

A suitable transmission system for such application delivery is known from ISO/IEC International Standard 13818-6, “MPEG-2 Digital Storage Media Command and Control” Jul. 12, 1996 (identified herein as DSM-CC). In modern digital broadcast systems a transmitter typically transmits a large number of services (or channels) to a plurality of receivers, examples of which are to be found in television sets or set-top boxes. Such a service can contain an audio/video stream, an interactive application (for example in the MHEG-5 format), other kinds of data or a combination of these elements. An MPEG-2 transport stream is a multiplex of a number of services, and a transmitter will typically transmit several transport streams to the set-top boxes. In turn, a suitably configured set-top box can tune to a specific transport stream and is then able to retrieve information from that transport stream.

As mentioned above, interactive multimedia applications are typically broadcast in a carousel-like fashion with successive data sections being repeated periodically and sequentially in the transport stream. For instance, both DVB and DAVIC have specified DSM-CC object carousels, as mentioned above, for broadcasting interactive applications.

DVB specifies a method of carrying a file system within a DVB Transport Stream. This is used for data broadcasting and for interactive broadcast systems. For instance it is the chosen method for broadcasting MHEG-5 objects in the UK terrestrial implementation of DVB, and it is used for Java class files and their associated data in the MHP specification from DVB.

As is described in the commonly-assigned International patent application WO 99/65230, the objects of a DSM-CC object carousel are broadcast in modules and provide a “virtual” file system comprised of file and directory objects in a hierarchy in the manner of a personal computer (PC) file system. Such a module is a container of objects and comprises a number of Download Data Block messages (which are specified in the MPEG-2 standard as private sections). When a set-top box wants to pre-fetch a DSM-CC object, it must (amongst other things) know in which module the object resides. After it has retrieved the right module, the set-top box must then parse the module to get to the object itself. Due to the hierarchical nature of the DSM-CC object carousel an object might be included in a subdirectory. If this is the case, the set-top box must also retrieve the module(s) with the intermediate directories, and parse them before it gets to the object in which it is interested.

Typically, the service provider will broadcast the object carousel in a compressed form. This compression is normally done at the module level. Thus, selecting a specific object for storage requires also the decompression of all the modules that are needed for the identification of the objects the settop box is interested in. As will be recognised, the hierarchical nature of the DSM-CC object carousel for the purpose of identifying objects requires a lot of processing in the set-top box. Consequently, when considering the issue of recording as an adjunct to capture of digital video broadcasts, it will be recognised that there is a lack of an efficient way to record (and play-back) object carousels.

In such set-ups, the module is the unit of transmission, and it is thus not possible to send a part of a module; either the entire module is sent or nothing is sent. Furthermore, the module is the unit of packaging, with the objects in a module being typically compressed together.

File and directory objects can change over time. Amongst the characteristics of modules and objects is that the grouping of objects in modules does not need to be constant over time. Objects can be moved between modules, and objects can be added and removed.

Since modules are broadcast in MPEG-2 transport streams, and each module is broadcast in the private data sections of an elementary stream, then typically a large number of modules will share the same elementary stream and a complete object carousel will generally be carried on only a limited number of elementary streams (typically fewer than 5). The elementary streams on which a module is carried may also be varied with time.

As will be recognised by the skilled practitioner, the object carousel consists of three layers, wherein the top layer consists of the file and directory objects, the layer below that consists of modules, and the layer below that consists of private data sections in an elementary stream. The problem is how to identify which parts of a data broadcast (Object Carousel) are relevant to a particular application without fully processing the application. The problem becomes significant when there is a requirement to store interactive applications rather than simply process them as they are delivered. Ideally the aim is to use limited processing resources to store the necessary parts of the data so that the application can be used at some later time. If it is necessary to process the carousel fully before it can be stored, the resulting overheads mean that it may not be feasible to store the application at all.

It is accordingly an object of the present invention to facilitate the recording of an multimedia platform-specific application, where it is necessary to record an application specified in one or more object carousels (or a part of an object carousel), wherein the recording process can be managed such that the required storage space is minimal and such that the complexity is manageable.

In accordance with a first aspect of the present invention there is provided a transmission system comprising a transmitter and at least one receiver configured to receive a signal stream transmitted therefrom, wherein broadcast data in the transmitted stream is accompanied by one or more applications defined in one or more data carousels formed of data file and directory objects sent in cycles with predetermined groups of file and directory objects being formed into respective modules at the transmitter and with each module being transmitted as a whole wherein, for each object carousel defining the root of the hierarchy of data objects, there is transmitted in the stream a list of identifiers for the component data carousels respectively defining all or a part of the data objects associated with an application, and the receiver is arranged, on identification of a particular application to be recorded, to use the list of identifiers to identify and subsequently store the received component data carousels for that application. By inclusion of the list of identifiers, it is no longer necessary to process each carousel down to the module level to identify whether or not it relates to (is referenced by) a particular application.

The transmitter may be arranged to include in the transmitted stream information identifying storage requirements for transmitted modules, and the receiver may be arranged to identify such information in the received stream and store the received modules with reference thereto. In such a case, the information may include, for each module, an indicator identifying whether or not that module is referenced by a further data object from another carousel. With such an indicator, the receiver may be arranged to perform memory reclamation by periodically identifying and deleting those modules that are not referenced.

Also in accordance with the present invention there is provided a transmitter for use in a transmission system comprising said transmitter and at least one receiver configured to receive signals transmitted therefrom, wherein said transmitter is arranged to deliver broadcast data in the transmitted stream accompanied by one or more applications defined in one or more data carousels formed of data file and directory objects sent in cycles with predetermined groups of file and directory objects being formed into respective modules at the transmitter and with each module being transmitted as a whole wherein, for each object carousel defining the root of the hierarchy of data objects, there is transmitted in the stream a list of identifiers for the component data respectively defining all or a part of the data objects associated with an application.

Further, the present invention provides a receiver for use in a transmission system comprising a transmitter and at least one said receiver configured to receive signals transmitted therefrom, wherein broadcast data in the transmitted stream is accompanied by one or more applications defined in one or more data carousels formed of data file and directory objects sent in cycles with predetermined groups of file and directory objects being formed into respective modules at the transmitter and with each module being transmitted as a whole wherein, for each object carousel defining the root of the hierarchy of data objects, there is transmitted in the stream a list of identifiers for the component data respectively defining all or a part of the data objects associated with an application, and the receiver is arranged, on identification of a particular application to be recorded, to use the list of identifiers to identify and subsequently store the received data objects for that application.

According to a further aspect of the present invention there is provided a multiplex signal comprising broadcast data accompanied by one or more applications defined in one or more data carousels formed of data file and directory objects carried in cycles with predetermined groups of file and directory objects having being formed into respective modules and with the signal containing each module as a whole wherein, for each object carousel defining the root of the hierarchy of data objects, the signal includes a list of identifiers for the component data carousels respectively defining all or a part of the data objects associated with an application. The invention further provides a data storage device having such a signal recorded therein or thereon.

Additional features of the present invention are defined in the attached claims, to which reference should now be made, and the disclosure of which is incorporated herein by reference. Further features are also disclosed in the following description of exemplary embodiments of the invention.

Embodiments of the invention will now be described by way of example with reference to the accompanying drawings in which:

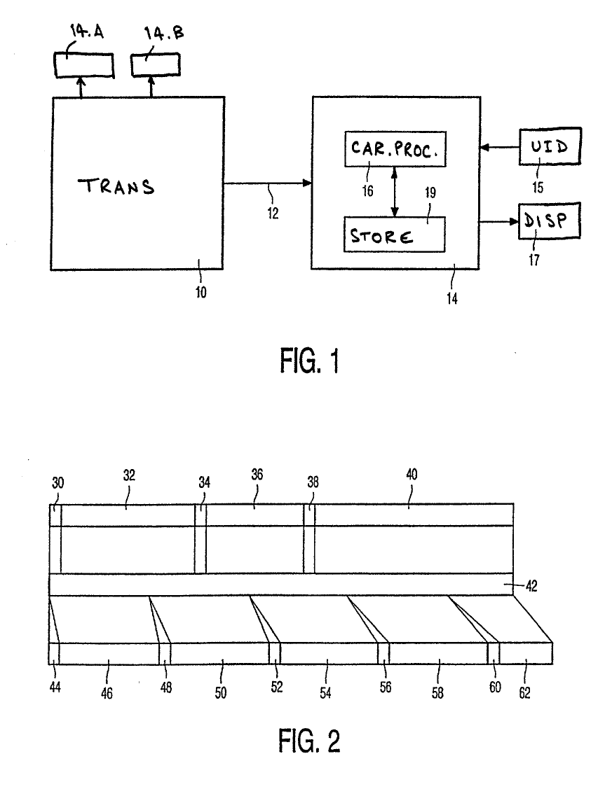

FIG. 1 shows a block diagram of a transmission system suitable to embody the invention;

FIG. 2 schematically shows the lower-level layering used in the construction of modules for DSM-CC object carousels;

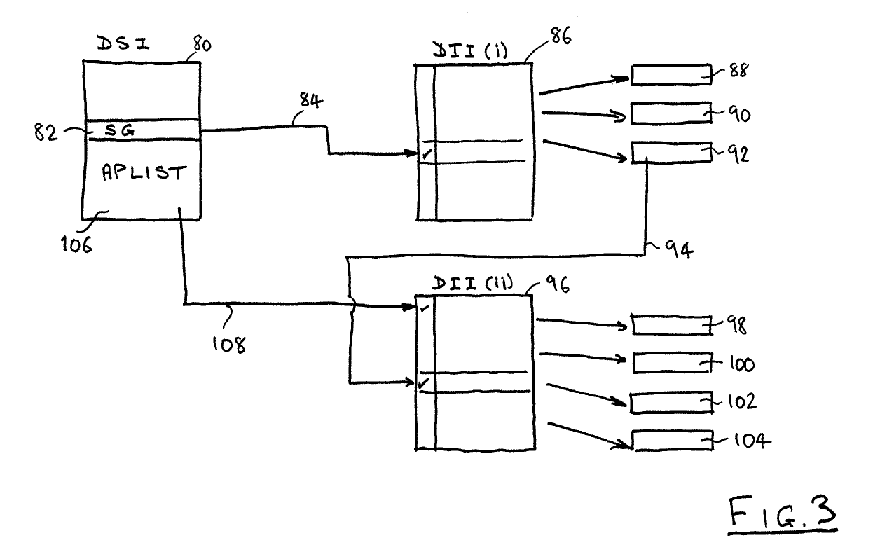

FIG. 3 represents an arrangement of carousels identifying respective modules according to the present invention; and

FIGS. 4 to 6 are tables listing respective characteristics of a first, second and third service descriptor for use in conjunction with the present invention.

The DVB (Digital Video Broadcast) standard specifies a method of carrying a hierarchical file system within a DVB Transport Stream. This is used for data broadcasting. It can be used for carrying any data of the sort that would normally be stored in a computer file system. It is frequently used for carrying data files for interactive broadcast systems. For instance, it is the chosen method for broadcasting MHEG-5 objects in the UK terrestrial implementation of DVB, and it is used for Java class files and their associated data in the MHP specification from DVB.

FIG. 1 shows a block diagram of a transmission system suitable to embody the invention. In such a transmission system, a number or stream of multiplex signals 12 are transmitted by a transmitter 10 to a receiver 14. The transmission system may comprise further receivers 14.A, 14.B, and may, for example, be used in a cable television (CATV) network environment, whereby the transmitter 10 comprises the headend of the CATV-network and the receivers 14 comprise the set-top boxes or the television sets of the end-users. The end-users are able to control a receiver 14 by means of a user-input device (UID) 15, like for instance a keyboard, a remote control or one or more control devices mounted on the receiver unit itself. The end-users can view the selected services on a display device (DISP) 17 which, where the receiver 14 is housed in a television set, may be integral with 14.

The multiplex signals 12 can be implemented in the form of MPEG-2 transport streams. An MPEG-2 transport stream is a multiplex of a number of so-called services. Such a service can contain an audio/video stream, an interactive application (for example in the MHEG-5 format), other kinds of data or a combination of these elements. Typically, a headend 10 transmits several transport streams 12 to the set-top boxes 14. In this way, a large number of services (or channels) can be broadcast by the headend 10 to a plurality of set-top boxes 14.

A set-top box 14 can tune to a specific transport stream 12 and is then able to retrieve information from the transport stream 12. Such a set-top box 14 typically has only one tuner and is thus merely able to receive a single transport stream 12 at a time. When a user wants to look at a television program, or wants to run an interactive application, or wants to access other kinds of data the set-top box 14 tunes to the corresponding transport stream 12 and retrieves and/or processes the required data from the service as it is being broadcast at that moment.

Interactive applications such as Tele-banking, Tele-shopping or information services are typically broadcast in a carousel-like fashion, i.e. the therewith corresponding data sections are repeated periodically in the transport stream 12. For instance, both DVB and DAVIC have specified DSMCC object carousels for broadcasting interactive applications. The response time and processing capability of such applications can be improved by the provision of local storage 19 in the receiver, which storage may be in the form of a hard disk or other (preferably non-volatile) memory, and may further be used for storing linear television content (audio/video) received from the transmitter 10. The store 19 may be used for caching in the receiver, for example pre-fetching or otherwise storing data sections or objects. Storage of objects is handled by processor 16 in the receiver, which processor further handles the treatment of Object Carousels, as will be described in detail hereinafter.

The DSM-CC system has been designed to provide a solution to the problem of efficient transport over a serial connection of a hierarchical file system. It can be parsed and the hierarchical directory structure, file names, and the content of the files can be recovered in the receiver.

In FIG. 2 the layered structure of a module for DSM-CC object carousels is shown. The objects of a DSM-CC object carousel are broadcast in such modules. Such a module is a container of objects and comprises a number of DownloadDataBlock messages (which are MPEG-2 private sections). In FIG. 2 module 42 comprises the objects 32, 36 and 40. These objects are included in so-called BIOP-messages. In such a BIOP-message the object is preceded by a message header. In FIG. 2 a first BIOP-message comprises a message header 30 and the object 32, which object 32 may include directory information. A second BIOP-message comprises a message header 34 and the object 36, which object 36 may include stream information. A third BIOP-message comprises a message header 38 and the object 40, which object 40 may include file information.

Furthermore, the module 42 comprises five DownloadDataBlock messages. These DownloadDataBlock messages consist of a header and a data block. The first DownloadDataBlock message is formed by header 44 together with data block 46, the second DownloadDataBlock message is formed by header 48 together with data block 50, the third by header 52 and data block 54, the fourth by header 56 and data block 58, and the fifth by header 60 and data block 62.

Based on the layering of the object carousel, the recording of the object carousel can be done on each of the three layers. Recording at the top layer means that the files and directories of an application are stored in a (regular) file system.

Recording of the object carousel may be undertaken at the elementary stream level: this has the advantage that it is generally simple and independent of the specifics of the object carousel. The drawback of this approach is however that of the costs in terms of storage capacity, because each cycle of the carousel is stored over and over again. If much of the carousel content does not change between cycles, then the recording will contain a notable amount of redundancy. In a further arrangement, the recording of an object carousel may be undertaken at the module level.

The capture and storage of carousel component modules at the elementary stream or module level further assists the efficient play back of an application by providing the modules to the application on demand, especially when the device that contains the recorded modules is a different device from the one that runs or will run the recorded application. That is, the object carousel is not reconstructed during playback (although that certainly is a valid option), but a module is only sent to the multimedia platform-specific device when the multimedia platform-specific device explicitly asks for a module. This has the advantage that the multimedia platform-specific device observes a minimal latency when acquiring a module. This typically gives a significant performance improvement compared to a live object carousel broadcast or compared to the situation where the storage device reconstructs the object carousel during play back.

Unfortunately the solution adopted within DVB requires the full parsing of the broadcast data structures to identify which components of the stream must be analysed. There is no high-level signalling to indicate which parts of the stream (which elementary streams) contain essential information for the reconstruction of the file system.

In normal usage, where the file system is reconstructed from the live broadcast as it is used this is not a problem. However, if we wish to store the stream, it is very convenient to have indicated, at a high level in the syntax, which components are necessary.

The problem is how to identify which parts of a data broadcast are relevant to a particular application without fully processing the application. The problem becomes significant when there is a requirement to store interactive applications rather than simply process them as they are delivered. The preferred solution is to use limited processing resources to store the necessary parts of the data so that the application can be used at some later time. If it is necessary to process the application fully before it can be stored, it may not be feasible to store the application at all.

An interactive application may be transported in one or more Object Carousels and may access one or more streams from within the Transport Stream (or even another Transport Stream).

Terminology:

In the following examples, the terminology is that used in the MPEG and DVB standards. However, these are used as generic terms for the generic concepts and apply to other implementations in other broadcast environments. Examples relevant to a DVB system are given in italics.

Transport Stream—a data stream containing a multiplex of elementary streams, which comprise a set of services.

e.g. MPEG-2 transport stream

Elementary Stream—a data stream consisting of a single item of media or data.

e.g. MPEG-2 elementary stream

Service—A description of a set of elementary streams of various types, which together comprise the traditional ‘TV program’. The service includes type information and descriptors for each of the elementary streams referenced.

e.g. DVB Service encoded in a Program Map Table (PMT)

Data Carousel—a broadcast of a set of generic data modules, repeated in a carousel fashion, delivered over one or more elementary streams. The data carousel consists of a message listing the set of modules and descriptors about those modules.

e.g. DSMCC DataInfoIndication (DII) messages

Module—a single item of data delivered in a data carousel. It may be constructed from a set of smaller separate broadcast units.

e.g. DSMCC module, composed from DSMCC DownloadDataBlocks (DDBs) encoded as MPEG-2 private sections

Object Carousel—a hierarchy of data objects, analogous to a computer file system, but delivered as a set of data carousels. An object carousel consists of data delivered using one or more data carousels, and a reference to a root object in the hierarchy. An object carousel typically interprets a module as a sequence of data objects. The data objects can be of a variety of types, including file and directory types. An object representing a directory (such as the root object) can then refer to other objects in the same or other data carousels.

e.g. DVB Object Carousel uses the DSMCC DownloadServerInitiate (DSI) message to refer to the ServiceGateway (root directory) of a filesystem. The modules consist of a sequence of Broadcast Inter-ORB Protocol (BIOP) messages, which are referred to using Inter-operable Object References (IOR).

Considering the issue of finding the essential elements of an Object Carousel, current specifications do not define explicit signalling to determine which Elementary Streams contain sufficient content for the reconstruction of an Object Carousel. The Service will contain descriptors indicating which Elementary Stream contains an Object Carousel.

e.g. the PMT carries a carousel_id_descriptor on the stream carrying the DSI message.

Note that this merely contains a reference to the ‘root’ object of the Object Carousel. The bulk of the data may be in this or other Elementary Streams. All other Elementary Streams that carry Data Carousels can also be identified by type information.

e.g. the stream_type, and by the data_broadcast_descriptor associated with them.

An object in the Object Carousel may potentially access Data Carousels outside the current Service. However, the Service maintains information about the location of these other Services which allows, in principle, the required Elementary Streams in that Service to be identified.

e.g. BIOP Profile Body which uses an association_tag listed in the deferred_association_tags of the PMT.

Also, an object in the Object Carousel may potentially access objects in other Object Carousels, on completely separate transports. These external links would not normally be preserved on storage.

e.g. Lite Options Profile Body refers to external content using NSAP addresses.

Thus we can find the set of all Elementary Streams that may contain data necessary for the Object Carousel without “deep parsing” of the Object Carousel (by “deep parsing” we mean inspection of the Object Carousel structures below the Data Carousel level). However, in cases where there is more than one Object Carousel on the Service, it is not easy to identify which Elementary Streams are required by each carousel. It is only possible to identify the Elementary Streams by fully parsing all the object references used within the Object Carousel.

A practical case where two carousels may be used in one service is an interactive broadcast (eg a sports application that a user might wish to record) combined with a normal Digital Teletext Service (which the user might not wish to record). They might be carried in separate Object Carousels on separate Elementary Streams. The data for each Object Carousel could be carried on several Elementary Streams. Some of the data might be shared between the two Object Carousels. There is no easy way to identify which parts of the data are needed by each application. The Sports application is likely to be rather small in size, whereas the Teletext application may be rather large.

The applicants propose to include a list of Elementary Streams that are used by the Object Carousel at the top-level Object Carousel object.

e.g. Add a list of association_tags to the DSI message.

The following embodiment of the invention, described with reference to the schematic diagram of FIG. 3 and the tables of FIGS. 4 to 6, includes a general description of the embodiment, together with relevant examples in italics using the DVB Object Carousel.

Referring first to FIG. 3, a DSI message 80 carries reference 82 to the ServiceGateway (root directory) of the file system providing a pointer 84 into a first data carousel (DII(i)) 86. This first data carousel 86 comprises a listing of a set of modules 88, 90, 92. One of the modules 92 of the first data carousel may carry a reference 94 into a second data carousel (DII(ii)) 96, with the second data carousel in turn listing a respective set of modules 98, 100, 102, 104. Conventionally, in order to identify the data carousels associated with a given application, it would have been necessary to deep parse the first data carousel 86 to the module level in order to discover the reference 94 to the second data carousel 96. In order to avoid this task, the DSI message includes a list of additional pointers (APLIST) 106 which provide a reference 108 to each additional data carousel (beyond the first already identified by the ServiceGateway 82).

The proposed embodiment is an extension to the top-level messages expressing the Object Carousel and Data Carousels. New descriptors are defined for listing the complete set of Data Carousels, describing the total expected size of the modules referenced (for estimating storage requirements), and timeouts for accessing further entries. As a further enhancement, individual modules within a Data Carousel can be ‘marked’ with descriptors describing where they are accessible from, which allows evaluation of which modules to store on a per-Data Carousel basis.

The DSI and DII formats specified for DVB Object Carousel are extended.

The specification of the top-level Object Carousel message is extended to allow a sequence of descriptors, as described below.

The ServiceGatewaylnfo( ):UserInfo field is used to contain the descriptors. The field is currently unused in Object Carousel. This specification defines that the field is to be interpreted as a descriptor loop.

Manifest descriptor—lists the complete set of Data Carousels that comprise this this Object Carousel. It does not include the Data Carousel containing the root directory itself—this is already referenced. The general form of this descriptor is shown in the table of FIG. 4.

An alternative embodiment is to use the Taps field of the DSI message to hold a sequence of Taps listing all DII components within the Object Carousel. The use of this field is as specified in the MPEG DSM-CC specification (ISO/IEC 13818-6), section 11.3) with the modification of semantics that the Taps list the complete set of DII messages as opposed to those required for initially attaching to the Object Carousel.

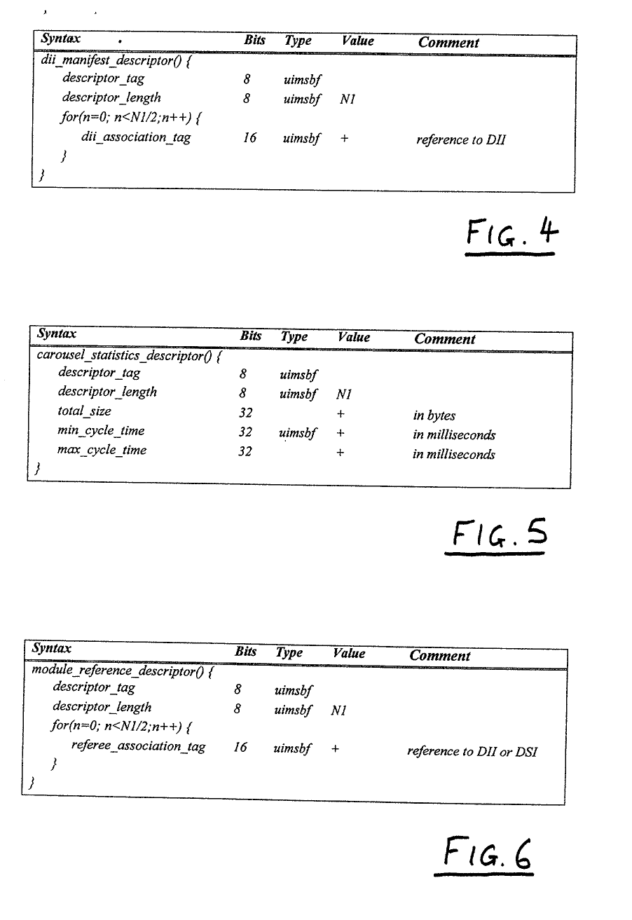

Carousel Statistics descriptor—gives information on the Object Carousel overall. Items that may be useful for storage are total size and overall cycle time. These can indicate overall space requirements, mean incoming bitrate, and how long this channel would have to be tuned to make storing worthwhile. The general form of this descriptor is shown in the table of FIG. 5.

There is currently no need for extensions at the Data Carousel level. Although it may seem to be sensible to have ‘referred data carousel descriptor’ here similar to the manifest descriptor, it should be remembered that the arrangement of Data Carousels does not have to mirror the hierarchy of the objects within the Object Carousel. There may be cyclic references between Data Carousels, and there may well be multiple entry points from other Dlls. Therefore encouraging recursive tracing through Dlls is not preferred.

The Data Carousel includes the list of modules, and extra descriptors are not added here.

DVB and MHP define the BIOP:ModuleInfo:UserInfo field as a descriptor loop, so we specify new descriptors here as a simple extension.

Module reference descriptor—lists references to the module from other Object or Data Carousels. This descriptor is present on all ‘entry modules’ in this Data Carousel. If present, this descriptor must list its own Data Carousel if there are references from other modules in the same Data Carousel. However, it is not valid for this descriptor to consist only of one reference from the owning Data Carousel.

An advanced storage device can use this information in combination with the manifest descriptor to work out whether storing this module is necessary. Also, once all modules in the Data Carousel have been loaded, a mark-sweep garbage collection process from these ‘root’ modules will cull unneeded modules. This is a crude method, because this sort of operation is best done at the object level, but this is a trade-off between storage and parsing overhead, and carousels will tend to be designed so that disjoint functionality will be stored in separate modules.

This descriptor is also a good indication of which modules are the priority modules needed to perform a full structure traversal of the carousel. This may be helpful in establishing an efficient search strategy for a storage device incapable requesting all modules in a Data Carousel at once (for example where there a fixed number of section filters available). The general form of this descriptor is shown in the table of FIG. 6.

The skilled reader will appreciate that, whilst the foregoing embodiments are described with reference to the MPEG-2 DSM-CC protocol, the invention is not limited to any specific protocol or form of data broadcast.

From reading the present disclosure, other modifications will be apparent to persons skilled in the art. Such modifications may involve other features which are already known in the design, manufacture and use of multimedia home platforms and applications and devices for incorporation therein and which may be used instead of or in addition to features already described herein.

1. A transmission system comprising a transmitter and at least one receiver configured to receive a signal stream transmitted therefrom, wherein broadcast data in the transmitted stream is accompanied by one or more applications defined in one or more data carousels formed of data file and directory objects sent in cycles with predetermined groups of file and directory objects being formed into respective modules at the transmitter and with each module being transmitted as a whole wherein, for each object carousel defining the root of the hierarchy of data objects, there is transmitted in the stream a list of identifiers for the component data carousels respectively defining all or a part of the data objects associated with an application, and the receiver is arranged, on identification of a particular application to be recorded, to use the list of identifiers to identify and subsequently store the received component data carousels for that application.

2. A system as claimed in claim 1, wherein the transmitter is arranged to include in the transmitted stream information identifying storage requirements for transmitted modules, and the receiver is arranged to identify such information in the received stream and store the received modules with reference thereto.

3. A system as claimed in claim 2, wherein said information includes, for each module, an indicator identifying whether or not that module is referenced by a further data object from another carousel.

4. A system as claimed in claim 3, wherein the receiver is arranged to perform memory reclamation by periodically identifying and deleting those modules that are not referenced.

5. A transmitter for use in a transmission system comprising said transmitter and at least one receiver configured to receive signals transmitted therefrom, wherein said transmitter is arranged to deliver broadcast data in the transmitted stream accompanied by one or more applications defined in one or more data carousels formed of data file and directory objects sent in cycles with predetermined groups of file and directory objects being formed into respective modules at the transmitter and with each module being transmitted as a whole wherein, for each object carousel defining the root of the hierarchy of data objects, there is transmitted in the stream a list of identifiers for the component data respectively defining all or a part of the data objects associated with an application.

6. A transmitter as claimed in claim 5, arranged to include in the transmitted stream information identifying storage requirements for transmitted modules.

7. A transmitter as claimed in claim 6, wherein said information includes, for each module, an indicator identifying whether or not that module is referenced by a further data object from another carousel.

8. A receiver for use in a transmission system comprising a transmitter and at least one said receiver configured to receive signals transmitted therefrom, wherein broadcast data in the transmitted stream is accompanied by one or more applications defined in one or more data carousels formed of data file and directory objects sent in cycles with predetermined groups of file and directory objects being formed into respective modules at the transmitter and with each module being transmitted as a whole wherein, for each object carousel defining the root of the hierarchy of data objects, there is transmitted in the stream a list of identifiers for the component data respectively defining all or a part of the data objects associated with an application, and the receiver is arranged, on identification of a particular application to be recorded, to use the list of identifiers to identify and subsequently store the received data objects for that application.

9. A receiver as claimed in claim 8, wherein, the transmitted stream including information identifying storage requirements for transmitted modules, the receiver is arranged to identify such information in the received stream and store the received modules with reference thereto.

10. A receiver as claimed in claim 9, wherein said information includes, for each module, an indicator identifying whether or not that module is referenced by a further data object from another carousel.

11. A receiver as claimed in claim 10, arranged to perform memory reclamation by periodically identifying and deleting those modules that are not referenced.

12. A multiplex signal comprising broadcast data accompanied by one or more applications defined in one or more data carousels formed of data file and directory objects carried in cycles with predetermined groups of file and directory objects having being formed into respective modules and with the signal containing each module as a whole wherein, for each object carousel defining the root of the hierarchy of data objects, the signal includes a list of identifiers for the component data carousels respectively defining all or a part of the data objects associated with an application.

13. A data storage device having recorded therein or thereon a signal as claimed in claim 12.

14. A data storage device as claimed in claim 13, wherein the recording therein or thereon of said signal is in a format determined at least partially by storage requirements for modules within the signal, said storage requirements as identified by information in said signal.
